(19) United States
(12) Patent Application Publication
(10) Pub. No.: US 2009/0193479 A1
(43) Pub. Date: Jul. 30, 2009

(54) Method and apparatus for automatically notifying a renter of digital content when the rental period has expired

(75) Inventors: Jeffery Andrew Briller, Sherman Oaks, CA (US); William Pat Price, Rhome, TX (US); Timothy Elliott, Huntington Beach, CA (US)

Correspondence Address: Law Office of Scott C Harris Inc, PO Box 1389, Rancho Santa Fe, CA, 92067, US

(73) Assignee: VIZIO, Irvine, CA (US)

(21) Appl. No.: 12/022,792

(22) Filed: Jan. 30, 2008

(51) Int. Cl. H04N 7/173

(52) U.S. Cl. 725/109

(57) ABSTRACT

Digital content contained on physical media rented to a customer who fails to return said media once the rental term has expired. Date information encoded onto the media or encoded within the content is used to determine that the rental period has expired. If the media containing the expired content is residing in a media player, the user is notified through a plurality of notification schemes. Customers of expired digital content can also be notified if the media player is connected to the internet even if the media containing the content is not currently residing in the media player. This invention solves several problems currently effecting content rental services and allows the rental services to conserve costs normally associated with notifying customers that their rental has expired.

### BACKGROUND

Rental of digital content on physical media has been an established business methodology for many years. Many problems exist with such a rental.

One problem is the customer who fails to return the media. Some media rental companies have developed strategies where they debit a customer's credit card for the cost of the media. Typically the company in effect sells the content on the media to such a customer for more than the customer could have bought the same content for at a discount store.

This problem is very prevalent with on-line video rental businesses such as NetFlix and BlockBuster; however these tactics tend to alienate the customers. When customers fail to return media that had been mailed to them, the companies wait a period of time, and then contact the customer to remind them to return the movie they had rented. Most customers comply with the request to return the media. Some customers just claim that they have mailed the media back and that it must have been lost in the mail. This is an easy claim to make and one that is hard to disprove.

### SUMMARY

The present invention addresses this problem by allowing the company to invoke action by the media player device or a television when the rental period for the media has expired.

These behaviors can be as gentle as constantly reminding the customer that the rental period has expired and that the media should be returned. It can be as harsh as the player device refusing to play the content on the media.

Embodiments also allow for a behavior that permits the customer to renew the rental period or to purchase the media or the content if the media player supports such a purchase.

### BRIEF DESCRIPTION OF THE DRAWINGS

Embodiments of the present invention are illustrated by way of example, and not by way of limitation. The following figures and the descriptions both brief and the detailed descriptions of the invention refer to similar elements and in which:

FIG. 1 is a diagram depicting how behavior metadata is joined to a digital content file.

FIG. 2 is a diagram depicting an embodiment for placing metadata and digital content on a plurality of media and delivery mechanisms.

FIG. 3 is a diagram depicting one set of components of an embodiment.

FIG. 4 is a diagram depicting the how notification of expired digital content is displayed to a user who does not have the media or the content file currently accessible by the player device.

FIG. 5 is a diagram depicting how the rental notification metadata is placed onto optical media for successive rentals.

### DETAILED DESCRIPTION

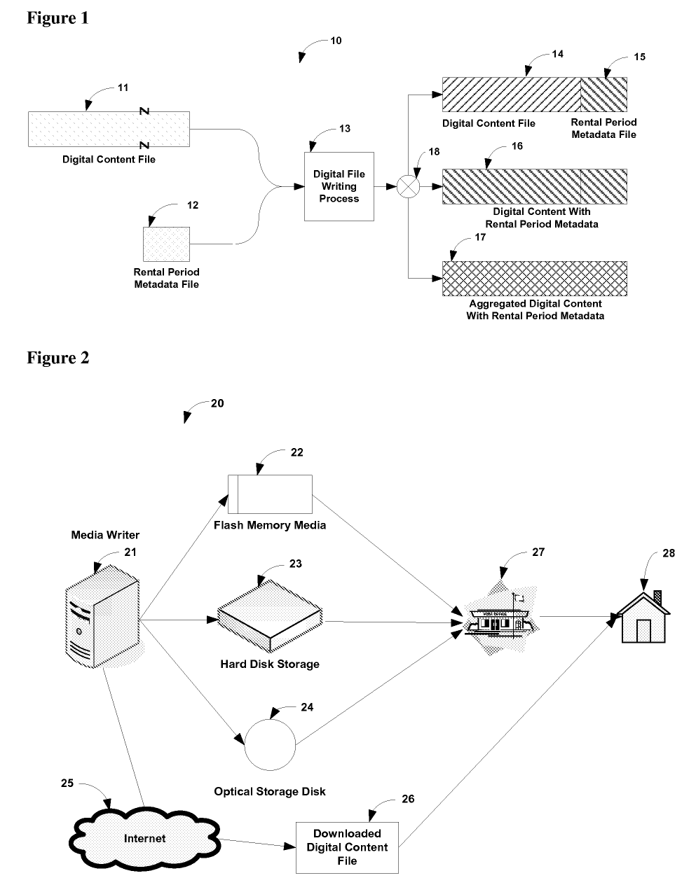

FIG. 1 shows a system 10 that includes a Digital Content File 11 and Rental Period Metadata File 12 which contains information concerning the rental period of Digital Content File 11. Rental Period Metadata File 12 may limit the rental period by limiting the time of rental, number of views, or by another method. Digital File Writing Process 13 aggregates Digital Content File 11 and Rental Period Metadata File 12 onto media. An Exclusive ‘OR’ function 18 may be used to allow a plurality of techniques to be used. The nature of Exclusive ‘OR’ function 18 is to allow any one of the three methods shown from a plurality of methods to be selected by Digital File Writing Process 13.

Three different embodiments are described. Digital File Writing Process 13 may write Digital Content File 11 and Rental Period Metadata File 12 on to the media as separate files shown as Digital Content File 14 and Rental Period Metadata File 15. In another embodiment, Digital File Writing Process may write Digital Content File 11 and Rental Period Metadata File 12 on to the media as Digital Content and Rental Period Metadata File 16 which is a single file created by the joining of the two files. In another embodiment, Digital File Writing Process may write Digital Content File 11 and Rental Period Metadata File 12 on to the media as Aggregated Digital Content and Rental Period Metadata File 16 which is a single file that may have been algorithmically constructed from the two files 11 and 12 such that they are not easily separated. The algorithm used to join the files together by Digital File Writing Process 13 may be any of a plurality of algorithms such as encryption or hashing.

System 20 in FIG. 2 depicts the plurality of delivery methods for the embodiments. Media Writer 21 writes one of a plurality of file formats containing digital content and rental period metadata as depicted in FIG. 1 onto any of a plurality of media such as Flash Memory Module 22, Hard Disk Storage 23, Optical Storage Disk 24, or through a download scheme by sending the Downloaded Digital Content File 26 over the Internet 25 to User's Home 28. Physical media Flash Memory Module 22, Hard Disk Storage 23, and/or Optical Storage Disk 24 delivery method utilizes US Postal 27 to deliver the physical media to User's Home 28.

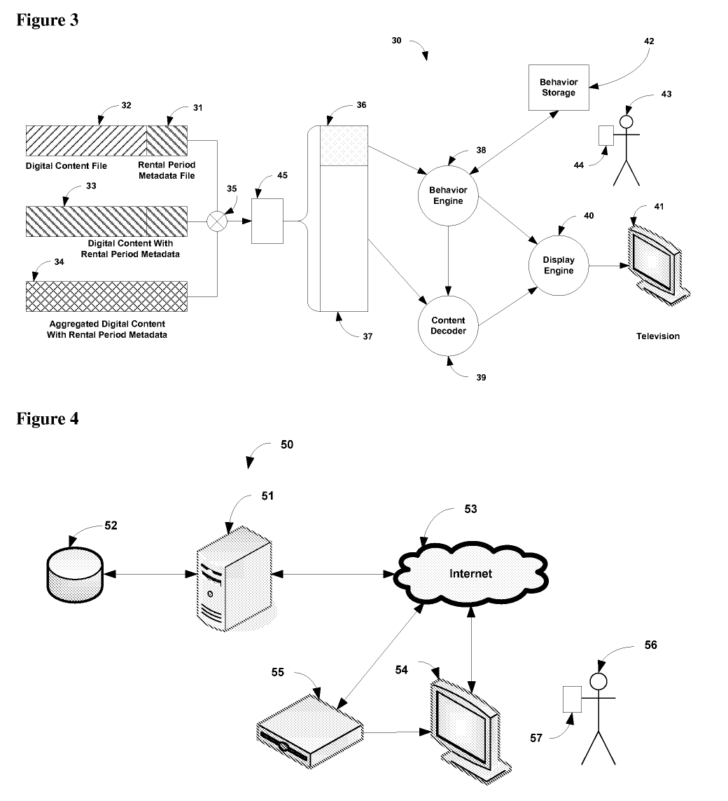

An embodiment 30 is shown in FIG. 3, in which three different formats of digital content and rental period metadata can be selected for processing by an Exclusive OR Function 35 and normalized by Normalizing Engine 45 to a single format usable by both Behavior Engine 38 and Content Decoder 39. In this embodiment, Digital Content File 32 and Rental Period Metadata File 31 are two individual files on a piece of media as illustrated in FIG. 2.

Digital Content With Rental Content 33 has both the digital content file and the rental period metadata files combined into a single file. Aggregated Digital Content With Rental Period Metadata 34 contains both the digital content file and the rental period metadata files algorithmically hashed together. After Normalizing Engine 45 has converted the selected file(s) into Rental Period Metadata File 36, Behavior Engine 38 processes the metadata to determine if the rental period has expired.

The rental period may be any of several different forms. For example, the rental period may be a range of calendar dates, a number of days, a number of hours, or some other measurable period of time or of events. Again for example, the rental period may be a fixed number of hours once an initial use of the digital content has started.

In this example, the digital content may be usable for 24 hours once the first use of the digital content has started. If Behavior Engine 38 determines that the rental period has expired, it sends a “Rental Expired” message to Display Engine 40 and a “Do Not Play” message to the Content Decoder 39. The form of the message sent by Behavior Engine 38 to Display Engine 40 may be of a plurality of formats such as text, graphic, or video. The display engine may be connected to the video screen 41 by a wire cable such as HDMI or component, by a wireless link such as 802.11 wireless protocol, or by some other means. In one embodiment, User 43 may indicate to Behavior Engine 38 through the use of a Remote Control Device 44 a desire to extend the rental period. Behavior Engine 38 in this embodiment may save that information in Behavior Storage 42 and through a set of rules notify Content Decoder 39 to play Digital Content File 37. If Digital Content File 37 is within the rental period, Content Decoder 39 decodes the file and sends it to Display Engine 40; which in turn processes the file and send the video to Television 41.

50 depicts a system of FIG. 4, where Media Player 55 and/or Television 54 are connected to the Internet 53 and accessible by Rental Computer 51. Rental Computer 51 can access its Rental Database 52 to determine that a rental media has not been returned by the user. In this embodiment, Rental Computer 51 sends a notification to either or both Media Player 54 and/or Television 55. The notification may be of a plurality of formats such as text, graphic, or video. User 56 observes the message sent to either Media Player 55 or Television 54 and is thus reminder to return the media to the renting company.

In an alternate embodiment, User 56 through the use of Remote Control Device 57 may extend the rental period of the digital content by Television 54 and/or Media Player 55 receiving user's agreement to extend and transferring that information back to Rental Computer 51 via Internet 53.

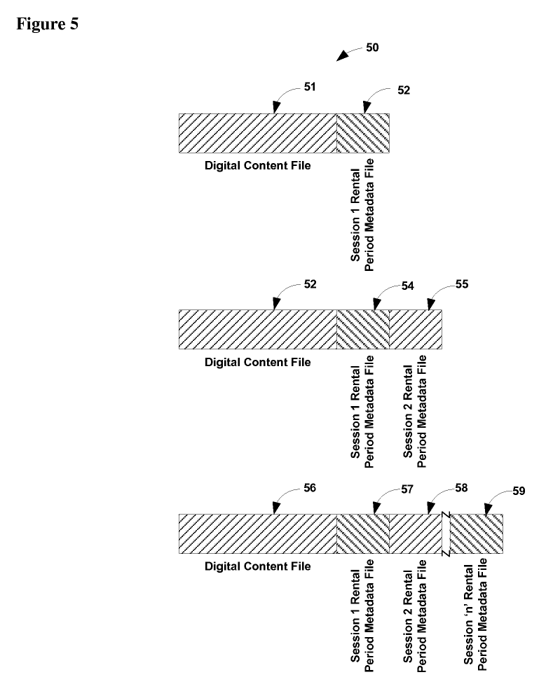

FIG. 5 shows an alternative set of processes 50 for changing metadata on write once optical media. This embodiment solves a problem where write once optical media which is typically used for rental DVDs. This type of media typically does not work well in an environment where some of the data needs to be changed prior to each rental. Write once media, however, can often have multiple sessions or partitions created one at a time in a serial fashion. In this type of embodiment, several megabytes of space on the media can accommodate hundreds of additional sessions containing small amounts of data. Considering that the space requirements for rental period metadata consume on the order of tens to hundreds of bytes of data, the number of additional sessions that could be written would exceed the usable life span of rental cycles.

For example, a single piece of DVD write once media may initially have Digital Content File 61 written on it and Session 1 Rental Period Metadata File 62 written. When the media is returned by a user, Session 2 Rental Period Metadata File 65 can be written as the next session prior to the media being sent to the next customer. This embodiment allows the media distributor to change the rental period rules at will. It also allows for the refreshing of metadata that may contain data other than rental period data. For example, the metadata may contain targeted ads that are specifically targeted to the next customer that will receive the media.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of media and players are contemplated, including newer players such as Bluray or HD-DVD.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A media player, comprising:
a reader, reading information off of physical media, and playing digital content based on said reading information, by reading the information and producing an output indicative of said information, said reader including a first microprocessor that controls the playing of digital content contained on said physical media, said computer program reading period information, determining when the rental period expires based on said period information residing on said physical media and said first microprocessor operative to notify said customer when said computer program determines the rental period of said content has expired.

2. A player as in claim 1, wherein said first microprocessor notifies said user by displaying a readable message as part of said output.

3. A player as in claim 1, wherein said first microprocessor notifies said user by terminating playing of said digital content when said rental period has expired.

4. A player as claim 1, further comprising connecting said digital content to a display screen via a cable.

5. A player as claim 1, further comprising connecting said digital content to a display screen via a wireless link.

6. A player as in claim 1, which further allows extending a rental period, and changes said information on said physical media to indicate that the rental period has been extended.

7. The player of claim 6, where said extending comprises writing a file to said physical media from said reader of a type that indicates update information to a customer's account.

8. The player of claim 6 where said reader is connected to the internet, and said extending comprises sending customer information and rental information to a processing center computer over the internet, where said data is read and said customer's account is updated.

9. The player of claim 1 where said reader reads an encrypted file as said period information, and uses said period information to determine when said period has expired.

10. The player of claim 6 where said information is written to write once memory.

11. A method, comprising:
reading digital content information from physical media using a media reader;
producing an output signal indicative of said digital content information, said output signal being viewable by a viewer;
controlling the playing of said digital content contained on said physical media;
reading period information from said physical media;
using a computer for determining when a rental period expires based on said period; and
notifying a viewer when said computer program determines the rental period of said content has expired.

12. A method as in claim 11, wherein said notify comprises terminating playing of said digital content when said rental period has expired.

13. A method as in claim 11, wherein said notify comprises terminating playing of said digital content when said rental period has expired.

14. A method as claim 11, further comprising connecting said digital content to a display screen via a cable.

15. A method as claim 11, further comprising connecting said digital content to a display screen via a wireless link.

16. A method as in claim 11, which further allows extending a rental period, and changes said information on said physical media to new period information to indicate that the rental period has been extended.

17. The method of claim 16, where said extending comprises writing a file to said physical media from said reader of a type that indicates update information to a customer's account.

18. The method of claim 17, further comprising processing said file when said media is returned to a first processing center where said file is read, and updating information indicative of a customer's account.

19. The method of claim 16 where said reader is connected to the internet, and said extending comprises sending customer information and rental information to a processing center computer over the internet, where said data is read and said customer's account is updated.

20. The method of claim 11 where said reading period information comprises reading an encrypted file.

21. The method of claim 16 where said new period information is written to write once memory.

22. A method as in claim 11, wherein said notify comprises displaying a readable message as part of said output.

23. A media player, comprising:
a reader, reading information off of physical media, and playing digital content based on said reading information, by reading the information and producing an output indicative of said information, said reader including a first microprocessor that controls the playing of digital content contained on said physical media, and said reader including an internet connection,
said player receiving expiration information over said internet connection indicating that the rental period for said physical media has expired, at a time when said physical media is not being read by said reader; and
said first microprocessor is operative to notify said customer when said expiration information indicates that the rental period of said content has expired.

24. A player as in claim 23, wherein said first microprocessor notifies said user by displaying a readable message as part of said output.

25. A player as in claim 23, wherein said first microprocessor notifies said user by terminating playing of said digital content when said rental period has expired.

26. A player as claim 23, where said first microprocessor allows extending a rental period, and changes said information on said physical media to indicate that the rental period has been extended.

27. The player of claim 26, where said first microprocessor writes a file to said physical media from said reader of a type that indicates update information to a customer's account.

28. The player of claim 27, wherein said first microprocessor writes an encrypted file to said media.
